(19) United States
(12) Patent Application Publication
(10) Pub. No.: US 2024/0125260 A1
(43) Pub. Date: Apr. 18, 2024

(54) HEATING MODULE FOR AN EXHAUST GAS SYSTEM OF AN INTERNAL COMBUSTION ENGINE AND ASSOCIATED METHOD

(71) Applicants: Friedrich Boysen GmbH & Co. KG, Altensteig (DE); Vitesco Technologies GmbH, Regensburg (DE)

(72) Inventors: Dennis SAILER, Altensteig (DE); Igor ROGOWSKI, Ravensburg (DE); Marco FRIESE, Pfalzgrafenweiler (DE); Oswald HOLZ, Bergisch Gladbach (DE); Manuel PRESTI, Roma (IT)

(21) Appl. No.: 18/227,771

(22) Filed: Jul. 28, 2023

(30) Foreign Application Priority Data
Oct. 18, 2022 (DE) 102022127238.9

(51) Int. Cl. F01N 3/20; B01D 53/94; F01N 3/10; F01N 3/28; F01N 9/00

(52) U.S. Cl. CPC F01N 3/2013; B01D 53/944; B01D 53/9495; F01N 3/103; F01N 3/2066; F01N 3/2892; F01N 9/00; F01N 2610/1453; F01N 2900/1404; F01N 2900/1602

(57) ABSTRACT

The invention relates to a heating module for an exhaust gas system of an internal combustion engine, said heating module comprising at least one inlet opening and at least one outlet opening by means of which the heating module can be connected to the exhaust gas system, wherein a main line and a secondary line are provided between the inlet opening and the outlet opening to guide an exhaust gas flowing through the heating module, said main line and secondary line being in connection with one another at their upstream ends via a branching section and at their downstream ends via a merging chamber. A control device for controlling the exhaust gas flow flowing through the main line is further provided in the main line. The heating module is characterized in that the heating module comprises an oxidation catalyst that is at least sectionally arranged in the merging chamber. The invention further relates to a corresponding method.

The invention relates to a heating module for an exhaust gas system of an internal combustion engine and to a method for operating said heating module.

In view of the increasing importance of environmental protection aspects, the reduction of emissions is also an omnipresent topic in the automotive sector and in particular with respect to the use of internal combustion engines. Today's exhaust gas systems have long since ceased to have the sole function of removing exhaust gases that are produced by the internal combustion engine. The purification of the exhaust gases is also a main task of the exhaust gas system. For this purpose, particle filters, oxidation catalysts, and/or an SCR stage are installed, for example.

Particle filters, for example, trap soot in the exhaust gas to be discharged in order to purify the exhaust gas in this way. To prevent the filter from clogging due to the accumulation of the soot, the soot accumulated on the particle filter is burned off in a regeneration process. This procedure is called oxidation. Carbon black oxidation only occurs at temperatures above 600° C. It is indeed possible to lower the temperature of the soot oxidation, for example, by adding an additive; however, even in such a case, the addition of thermal energy is necessary to initiate the regeneration process. The addition of the thermal energy, for example, takes place by using upstream oxidation catalysts that oxidize hydrocarbons (HC) and carbon monoxides (CO) in the gas, wherein thermal energy is released during this reaction.

For an optimal operation of oxidation catalysts and SCR systems, they have to reach an appropriate operating temperature, wherein the reaching of the operating temperature is a problem, in particular shortly after the internal combustion engine has been started.

As is known from EP 2 691 614 B1, an oxidation catalyst is used for this purpose that is arranged in a heating module comprising two flow paths, namely a main line and a secondary line, in order to heat a portion of the exhaust gas, namely the portion of the exhaust gas that flows through the secondary line. In this respect, a heating element is connected in the secondary line in front of the oxidation catalyst in order to quickly heat the oxidation catalyst to a suitable operating temperature. The heated portion of the exhaust gas flow is then mixed with a portion of the exhaust gas flow flowing through a main line so that the total exhaust gas flow has an increased temperature to initiate the regeneration processes of the particle filter. It is also possible to substantially completely block the main line so that the exhaust gas flows almost exclusively through the secondary line.

It is an underlying object of the invention to provide an improved heating module for an exhaust gas system of an internal combustion engine and a corresponding method for heating components for an exhaust gas system of an internal combustion engine.

This object is satisfied by a heating module in accordance with claim 1 and by a method in accordance with claim 15.

In accordance with the invention, a heating module for an exhaust gas system of an internal combustion engine comprises at least one inlet opening and at least one outlet opening by means of which the heating module can be connected to the exhaust gas system, wherein a main line and a secondary line are provided between the inlet opening and the outlet opening to guide an exhaust gas flowing through the heating module, said main line and secondary line being in connection with one another at their upstream ends via a branching section and at their downstream ends via a merging chamber, wherein a control device for controlling the exhaust gas flow flowing through the main line is provided in the main line. Furthermore, an oxidation catalyst is provided that is at least sectionally arranged in the merging chamber.

Through the inlet opening, exhaust gas moves from the internal combustion engine into the heating module and in particular into the branching section. Via the branching section, the exhaust gas is guided into the main line and the secondary line that connect the branching section to the merging section. In this respect, the amount of exhaust gas that flows through the main line, and thus also indirectly the amount of exhaust gas that flows through the secondary line, is determined by means of the control device for controlling the exhaust gas flow flowing through the main line. For example, the control device comprises a control flap whose opening angle determines the amount of exhaust gas flowing through the main line.

The exhaust gas flow flowing through the secondary line, i.e. the secondary flow, flows at least partly, in particular completely, through the oxidation catalyst that is arranged at least sectionally, in particular completely, in the merging chamber and that brings about an HC or CO reduction in which thermal energy is released. Furthermore, the exhaust gas flow flowing through the main line, i.e. the main flow, flows into the merging chamber in which the exhaust gas flowing through the merging chamber at least sectionally surrounds the oxidation catalyst so that the oxidation catalyst is heated by the exhaust gas present in the merging chamber, in particular via its outer surfaces.

The invention thus builds on the idea that the exhaust gas flowing through the merging chamber flows around the oxidation catalyst and additionally heats it so that the oxidation catalyst reaches its operating temperature more quickly and/or through less externally added thermal energy.

An advantage of the invention is that the oxidation catalyst reaches its operating temperature more quickly than in conventional heating modules due to a further heat source, i.e. the exhaust gas flowing around the oxidation catalyst, so that an increase in efficiency of the heating module is achieved. A heating element associated with the oxidation catalyst can therefore be dimensioned smaller or has to be activated less than in conventional modules. Therefore, due to the arrangement in accordance with the invention of the oxidation catalyst, costs can be saved or the use of energy can be reduced. Furthermore, the manufacture of a very compact heating module, i.e. a heating module that saves as much space as possible, becomes possible due to the design in accordance with the invention of the heating module.

The control device can generally be designed such that it can substantially completely block or release the main line. Intermediate positions of the control device can likewise be provided. The control device is in particular continuously adjustable to be able to influence the gas flow through the heating module as required.

The control device can be in connection with a control unit of the heating module that controls the operation of the heating module based on sensor data and/or external signals.

In the blocked state, the exhaust gas substantially flows only through the secondary line. If the main line is fully released, the exhaust gas flows substantially completely or at least mainly through it since the secondary line generally has a greater flow resistance.

For example, on a cold start of the internal combustion engine, the main line is open so that the exhaust gas flows around the oxidation catalyst that is at least sectionally arranged in the merging chamber. The exhaust gas is indeed still comparatively cool at this point in time. However, the oxidation catalyst is already heated without active heating measures having to be taken. As soon as the oxidation catalyst has reached a desired temperature (for example, a temperature greater than 270° C.), the main line can be (partly) blocked to direct the exhaust gas substantially completely or partly through the secondary line. Hydrocarbons (HC) are introduced there that then oxidize exothermically in the oxidation catalyst that is already preheated and, if required, also actively heated. The oxidation catalyst therefore acts as a catalytic burner. The heat given off in this process is fed to the exhaust gas system so that other components of the exhaust gas system quickly reach the suitable operating temperature. As soon as the exhaust gas temperature has reached the required level, the main line is released again.

Further embodiments of the invention can be seen from the description, from the dependent claims and from the drawings.

In accordance with a first embodiment, the oxidation catalyst is arranged at an outlet of the secondary line. The secondary flow in this respect flows through the oxidation catalyst at least partly, preferably completely. It is also possible that the oxidation catalyst does not completely cover the outlet of the secondary line or is located at a predefined distance from the secondary line. In such a case, for example, a portion of the secondary flow flows through the oxidation catalyst, wherein another portion of the secondary flow flows directly into the merging chamber without flowing through the oxidation catalyst beforehand.

In accordance with a further embodiment, the oxidation catalyst is at least sectionally arranged spaced apart from a wall of the merging chamber. For example, a gap is provided at least sectionally and in particular in its entirety between the wall and in particular the inner wall of the merging chamber, on the one hand, and the oxidation catalyst, on the other hand, so that the oxidation catalyst is flowed around and heated at least sectionally and in particular in its entirety by exhaust gas in the merging chamber.

In accordance with a further embodiment, an end section of the secondary line is at least sectionally arranged in the merging chamber. It is hereby, for example, ensured that as large a portion as possible of the oxidation catalyst is arranged in the merging chamber to be flowed around by exhaust gas. For example, the end section of the secondary line projects into the merging chamber. In this respect, the end section is heated by the exhaust gas flowing through the merging chamber. The heated end section can, for example, effect an additional heating of the secondary flow and/or of the oxidation catalyst, which is possibly in contact with the end section, by means of heat conduction.

In accordance with a further embodiment, an end section of the secondary line has a widened portion. The axial cross-sectional surface of the outlet of the secondary line can hereby be increased so that an oxidation catalyst having a larger effective area can also be used, wherein the effective area of the oxidation catalyst represents the area of the oxidation catalyst that is flowed onto by the secondary flow. Due to the increased effective area of the oxidation catalyst, its oxidation conductance can further be increased so that an increased amount of exothermic energy is released. Conversely, an oxidation catalyst having an increased effective area can be shorter for the same performance, whereby a more compact design of the module is made possible. The widened portion is in particular funnel-like and symmetrical or asymmetrical, i.e. the radius of the end section of the secondary line at least becomes sectionally larger in the direction of flow.

In accordance with a further embodiment, the oxidation catalyst is plugged into or pushed into the widened portion and/or is otherwise fastened to the widened portion. Due to the plug-in or push-in fastening of the oxidation catalyst, a particularly simple assembly of the oxidation catalyst is possible.

Furthermore, the oxidation catalyst can, at a side facing the secondary line, comprise a projection at least partly in the peripheral direction, said projection engaging into the end section of the secondary line and thus forming a form-fitting connection with a component of the secondary line. It is to be understood such that the oxidation catalyst can also be fastened to the secondary line by any other suitable form of fastening or form of connection, for example, by a force-fitting connection, a bonded connection or a form-fitting connection of another design.

The oxidation catalyst can further comprise a fastening component that is fixed to the widened portion. For example, the oxidation catalyst can have a flange that can be fastened to a component of the secondary line or of the end section of the secondary line.

In accordance with a further embodiment, the merging chamber is provided with an at least sectionally funnel-like outlet cover that has the outlet opening. The funnel-like outlet cover can, for example, be symmetrical or asymmetrical. The funnel-like outlet cover in particular enables a “soft” merging of the partial exhaust gas flows, i.e. the exhaust gas flow that flows out of the oxidation catalyst and the exhaust gas flow that enters the merging chamber through the main line. The outlet cover is in particular designed such that the secondary flow and/or the main flow impacts/impact on walls of the outlet cover at an angle of impact that is preferably less than 90°, less than 60°, less than 45°, or less than 30°. As uniform as possible a mixing of the partial exhaust gas flows can hereby be ensured, for example. Furthermore, unfavorable impact flows are usually avoided in a technical flow aspect.

In accordance with a further embodiment, the merging chamber has an onflow wall for the main flow that is arranged inclined to the main flow direction of the main line. The inclined onflow wall has the effect that the main flow impacts the onflow wall of the merging chamber at an angle that is not too steep, i.e. in particular an angle of less than 90°, less than 60°, less than 45° or less than 30°, and hereby enables a “soft” further conveying of the main flow to the outlet cover. Furthermore, unfavorable impact flows are usually avoided in a technical flow aspect.

In accordance with a further embodiment, an injector is attached to the branching section and is configured to inject a fluid via a nozzle into the branching section and/or the secondary line. The injector is in particular arranged in parallel with, preferably coaxially to, a longitudinal axis of the secondary line at an outer side of the branching section. The fluid contains hydrocarbons (HC). For example, a fuel is injected that is also used for operating the internal combustion engine, for instance diesel. The amount of HC sprayed in or injected is preferably adapted to operating parameters of the internal combustion engine, of the exhaust gas system, and/or of the heating module. For this purpose, the injector can be connected to the control unit described above.

In accordance with a further embodiment, a swirl element is arranged in the branching section in order to impart a swirl component to the exhaust gas flow flowing through the secondary line. The swirl element in particular surrounds the nozzle in the peripheral direction.

The swirl element, for example, at least sectionally has a funnel-like or conical shape, wherein an opening side of the funnel-like swirl element can be fastened to an inner wall of the branching section and/or wherein a side disposed opposite the opening side can be open and can face the branching section or can project into it. The swirl element is in particular arranged coaxially to a longitudinal axis of the secondary line. For the generation of a swirl component, angled guide surfaces can be provided that are associated with openings in a conical base body of the swirl element. Exhaust gas passing through the opening is thereby given a swirl.

The swirl element is preferably arranged and configured such that the exhaust gas can reach the secondary line only after passing through the swirl element.

The swirl element is preferably arranged in the branching section such that it is laterally flowed onto by exhaust gas.

In accordance with a further embodiment, a sleeve-like throttle element is arranged in the branching section to influence the flow field of the exhaust gas flow. The swirl element in particular surrounds the throttle element in the peripheral direction. The throttle element in particular has a cylindrical shape or a conical shape and is provided with openings (e.g. a perforation at a lateral surface of the throttle element).

A nozzle-like sleeve element can be provided radially within the swirl element and/or the throttle element.

The swirl element, the throttle element, and the sleeve element—preferably designed as sheet metal components—can be combined with one another as desired, on the one hand, to prevent a dispersal of the spray cone of the injected fluid and, on the other hand, to effect a good mixing of the fluid in the exhaust gas flow. The latter is of particular importance since an onflow of the oxidation catalyst by a homogeneous HC distribution results in a more efficient catalytic combustion.

In accordance with a further embodiment, the oxidation catalyst can be actively heated. For example, the oxidation catalyst is directly energized to increase the temperature of the oxidation catalyst.

In accordance with a further embodiment, a heating element is provided for heating the exhaust gas flowing through the secondary line, in particular wherein the heating element is arranged in front of the oxidation catalyst in the direction of flow. The heating element is, for example, an electrical resistance heating element (e.g. a heating disk) that is energized. The positioning of the heating element in front of the oxidation catalyst in particular has the advantage that any fluid in the exhaust gas flow that has not yet evaporated can evaporate due to the increased temperature of the heating element before it impacts the oxidation catalyst. However, by positioning the heating disk upstream and preferably directly in front of the oxidation catalyst, the possibility is in particular provided of bringing the oxidation catalyst to a sufficient temperature. Only at a sufficient catalyst temperature does the exothermic reaction of HC take place at the catalyst. As soon as HC is metered in, a significantly higher heat input is produced than during a purely electrical heating. The electrical heating can thereby be reduced accordingly and the heat is produced primarily or even completely by the catalytic chemical reaction.

A control connected to the heating element or to a directly energizable oxidation catalyst can provide an energization as required.

In accordance with a further embodiment, the heating element is in contact with or is integrated into the oxidation catalyst. For example, the heating element is a heating disk that is in contact with the oxidation catalyst via an end face of the oxidation catalyst that faces the secondary line.

The invention further relates to an exhaust gas system comprising a heating module in accordance with at least one of the embodiments described above and an exhaust gas purification device arranged downstream of the heating module. Said exhaust gas purification device can be brought to operating temperature more quickly by the operation of the heating module after a cold start or a part-load operation of the internal combustion engine. The operation of the heating module also enables a regeneration of said device.

A further aspect of the invention relates to a method for operating a heating module for an exhaust gas system of an internal combustion engine, in particular a heating module in accordance with any one of the embodiments described above. In the method, an exhaust gas flow is guided into a branching section via an inlet opening of the heating module. The exhaust gas flow is then guided from the branching section as a main flow in a main line and/or is guided from the branching section as a secondary flow in a secondary line. The exhaust gas flow can thus flow through the heating module on two different paths.

The secondary flow flows at least partly through an oxidation catalyst for the catalytic combustion of a fluid introduced into the secondary flow. The secondary flow is heated by the catalytic combustion of the fluid introduced as required (for example, by means of an injector).

Then, the secondary flow and the main flow are combined in a merging chamber before the exhaust gas flow leaves the heating module via an outlet opening.

The oxidation catalyst is at least sectionally arranged in the merging section and is flowed onto by the main flow on operation of the heating module.

To operate the module efficiently and to heat the exhaust gas flow as required, a ratio of the mass flow of the main flow to the mass flow of the secondary flow is set by a control device arranged in the main line.

For example, the mass flow of the main flow is maximized until the oxidation catalyst and/or the exhaust gas flow exiting from the heating module has/have reached a first target temperature. The first target temperature can be in the range of a lower limit of the operating temperature of the oxidation catalyst. An exemplary value for the first target temperature is 270° C. Starting from a relatively cool state of the module, the oxidation catalyst is therefore initially substantially heated by the main flow. The first target temperature can be in the range from 250° C. to 500° C., in particular at 270° C.+/−10° C. or 270° C.+/−5° C., and in particular depends on the properties of the oxidation catalyst (e.g. on the type and composition of the catalytically active coating).

Although it will usually rather not be necessary, an active (in particular direct or indirect electrical) heating of the oxidation catalyst can generally already take place in the step described above.

Then, the mass flow of the main flow is reduced or minimized until the oxidation catalyst and/or the exhaust gas flow exiting from the heating module has/have reached a second target temperature that is above the first target temperature or until an external signal is received. The second target temperature can be in a range of the operating temperature of a downstream exhaust component. An external signal can be a signal of a higher-ranking control that is output and received by a control unit of the module when e.g. exhaust gas with a sufficient temperature arrives at the downstream exhaust gas purification device to heat it and/or when the exhaust gas purification device has reached the desired temperature. For example, such a signal is output when a temperature of 200° C. to 250° C. is determined behind an SCR system.

In the step described above, an active heating and/or a metering in of the HC fluid can optionally take place. In this step, a temperature window of 250° C. to 500° C. is preferably maintained, wherein the mass flow that flows through the secondary line, the active heating, and the metering in of HC are matched to one another. In this respect, a prioritization of the measures can take place, i.e. a corresponding regulation assigns a higher priority to the setting of the control device (i.e., for example, a flap position of the control device) than to the active heating of the oxidation catalyst that in turn has a higher priority than the metering in of HC.

Subsequently, the mass flow of the main flow is increased or maximized again if the second target temperature has been maintained for a predetermined time period and/or for a time period determined based on operating data of the heating module and/or based on external data or if an external signal is received. The time period is in particular a time interval that is required to heat a downstream exhaust gas purification device up to its operating temperature. An external signal can be a signal of the higher-ranking control that is output and received by the control unit of the module when the downstream exhaust gas purification device has reached its operating temperature.

For a temporary increase of the exhaust gas temperature in a normal operation of the module—e.g. to regenerate a downstream particle filter—the mass flow of the main flow is reduced or minimized until the oxidation catalyst and/or the exhaust gas flow exiting from the heating module exceeds a third target temperature that is above the second target temperature or until an external signal is received. The third target temperature can be a temperature that is required for the regeneration of the particle filter, e.g. 600° C. An external signal can be a signal of a higher-ranking control that is output and received by the control unit of the module when e.g. exhaust gas with a sufficient temperature arrives at a downstream exhaust gas purification device to regenerate it and/or when the exhaust gas purification device has reached the desired temperature.

The third target temperature can be maintained for a predetermined time period and/or for a time period determined based on operating data of the heating module and/or based on external data. The third target temperature is preferably in a range from 550° C. to 620° C., in particular at 600° C.+/−10° C. or 600° C.+/−5° C.

The term “target temperature” is to have a broad interpretation. It not only comprises discrete temperature values but also temperature windows since, in practice, certain temperature fluctuations cannot be ruled out in an operation of an exhaust gas system, even in a stable operation.

The ratio of the mass flows flowing through the two lines can be set by the control device (e.g. an exhaust gas flap) that—as already mentioned—is connected to a control unit, for example. The control unit can, for example, set the amount of exhaust gas flowing through the main line or through the secondary line based on a variety of incoming data, for example data of sensors that measure an exhaust gas temperature, an exhaust gas pressure, an exhaust gas flow velocity, or another parameter. Furthermore, the heating element, i.e. the energization of the heating element, and the injector, i.e. the amount of fluid injected, can also be controlled by means of the control based on the acquired sensor values. The control device, the heating element, and/or the injector are in particular controlled dependently on one another or independently of one another. The control unit can—as already mentioned—also be connected to a higher-ranking control that, for example, controls the internal combustion engine, among other things, so that further parameters can be considered for controlling the heating module.

The above-described mass flow ratio of the main flow to the secondary flow can be variably set between 1:0 and 0:1—on a suitable design of the module and a corresponding control.

The statements regarding the heating module in accordance with the invention apply accordingly to the method in accordance with the invention; this in particular applies with respect to the advantages and embodiments described.

In the following, the invention is presented purely by way of example with reference to an embodiment and to the drawings. There are shown:

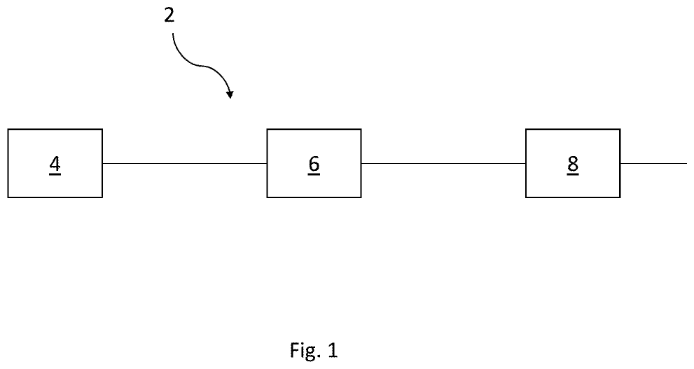

FIG. 1 an exhaust gas system that comprises a heating module;

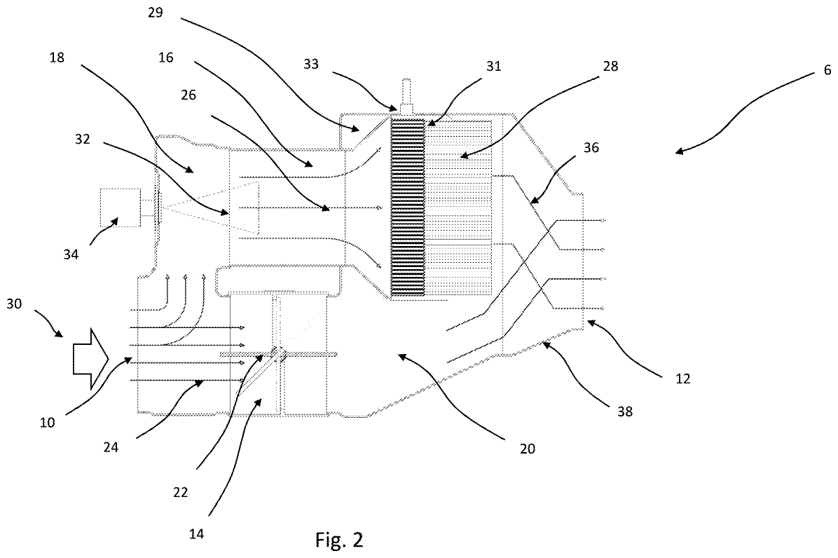

FIG. 2 a lateral cross-sectional view of an embodiment of the heating module;

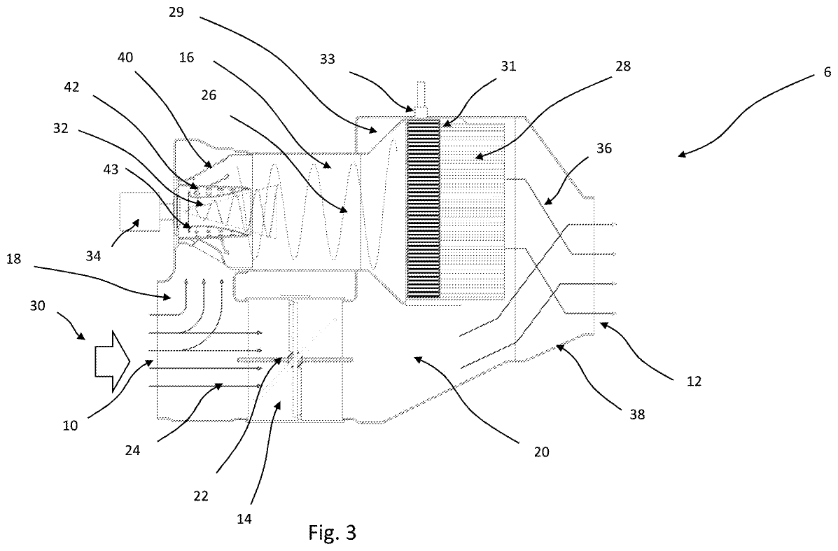

FIG. 3 a lateral cross-sectional view of a further embodiment of the heating module;

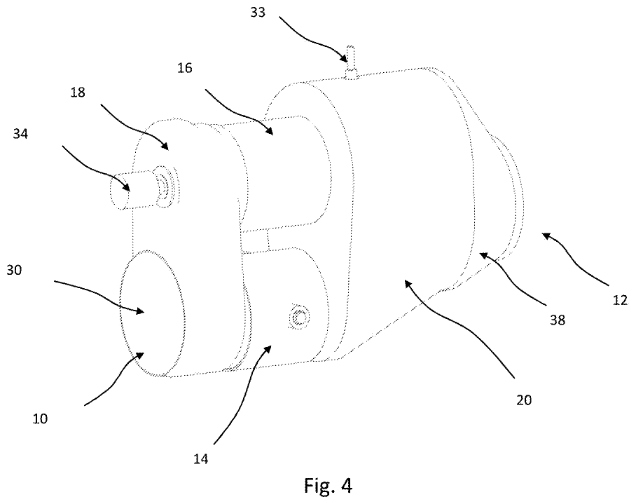

FIG. 4 a perspective view of the heating module;

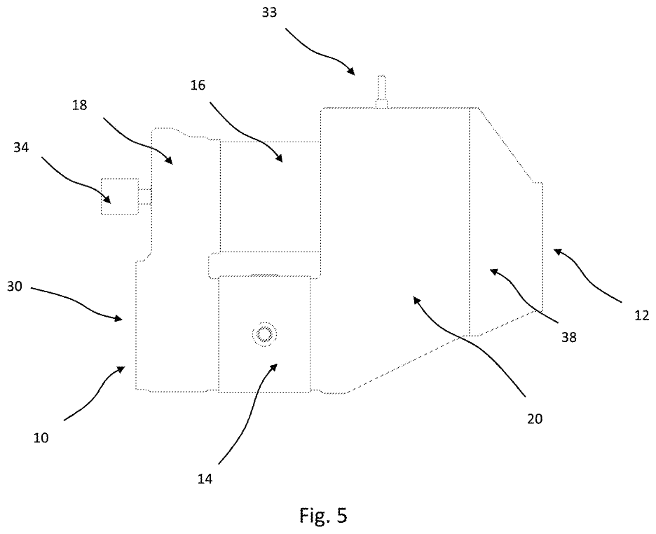

FIG. 5 a side view of the heating module; and

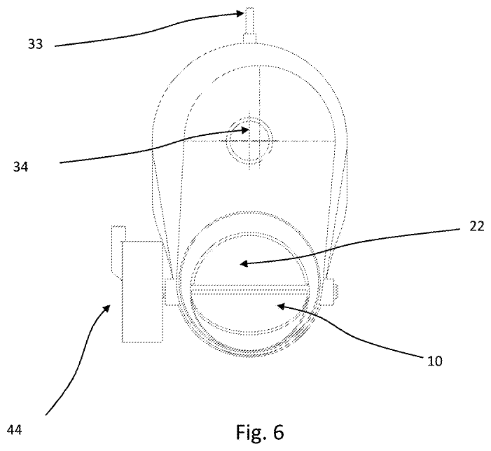

FIG. 6 a front view of the heating module.

FIG. 1 illustrates an exhaust gas system 2 that comprises an internal combustion engine 4, a heating module 6 connected to the internal combustion engine, and an exhaust gas purification system 8 in connection with the heating module 6. The internal combustion engine 4 in this respect generates exhaust gases that are discharged and purified via the exhaust gas system 2. The purification of the exhaust gases in particular takes place by the exhaust gas purification system 8 that, for example, has a particle filter and/or a catalyst.

The soot included in the exhaust gas accumulates in a particle filter and is burned off from time to time in a regeneration process. Since temperatures of over 600° C. are required for the regeneration process, the heating module 6 is attached between the internal combustion engine 4 and the exhaust gas purification system 8 and inter alia has the task of temporarily heating the exhaust gas flow to enable a regeneration process of the particle filter.

Catalysts, in turn, have the property that they only work efficiently from certain operating temperatures onward. The heating module 6 can therefore be used to provide a heating of the exhaust gas as required on a cold start or a part-load operation—i.e. when the exhaust gas exiting from the internal combustion engine is comparatively cold—in order to quickly bring a downstream catalyst to operating temperature.

FIG. 2 shows an embodiment of the heating module 6 in a lateral cross-sectional view. The heating module 6 comprises an inlet opening 10 and an outlet opening 12 by means of which the heating module 6 can be connected to the exhaust gas system 2, wherein a main line 14 and a secondary line 16 are provided between the inlet opening 10 and the outlet opening 12 for guiding an exhaust gas flowing through the heating module 6, said main line 14 and secondary line 16 being in connection with one another at their upstream ends via a branching section 18 and at their downstream ends via a merging chamber 20. The main line 14 further comprises a control device 22 in the form of a control flap for controlling the main flow 24 flowing through the main line 14. A change in the main flow 24 has the result that a secondary flow 26 flowing through the secondary line 16 is also changed. Thus, the secondary flow 26 can ultimately be controlled by the control of the main flow 24.

The heating module 6 further comprises an oxidation catalyst 28 that is completely arranged in the merging chamber 20 and that is fastened to an end section 29 of the secondary line 16, wherein the end section 29 of the secondary line 16 is arranged completely in the merging chamber 20 in FIG. 2. In accordance with the invention, on a cold start or a part-load operation, the catalyst 28 is heated to a desired temperature, in particular its operating temperature, by the exhaust gas flowing around said catalyst 28 in the merging chamber 20.

As shown in FIG. 2, a heating disk 31 is furthermore arranged in front of the oxidation catalyst 28 and actively heats a hydrocarbon exhaust gas mixture flowing onto the oxidation catalyst 28 and, to a certain extent, also heats the oxidation catalyst 28 itself in order to quickly reach the temperature required for the catalytic combustion. The heating disk 31 is connected via a connector 33 to a control unit, not shown, that controls the temperature of the heating disk.

The course of the exhaust gas flow through the heating module 6 is described in more detail in the following.

The exhaust gas generated by the internal combustion engine 4 is guided as an input exhaust gas flow 30 via the inlet opening 10 into the branching section 18, where a portion of the input exhaust gas flow 30 is fed to the main line 14 and/or the secondary line 16. The main line 14 and/or secondary line 16, for example, comprises/comprise tubular sections. The amount of exhaust gas flowing through the main line 14 and the amount of exhaust gas flowing through the secondary line 16 are controlled via the control flap 22. The control flap 22 is connected to an actuator, not shown, that is connected to a control unit, not shown. Based on the setting angle of the rotatably supported control flap 31, the amount of exhaust gas flowing through the main line 14, and thus indirectly the amount of exhaust gas flowing through the secondary line 16, is determined. When the control flap 22 is perpendicular to the direction of flow of the main flow 24, nearly all of the input exhaust gas flow 30, for example, flows via the branching section 18 into the secondary line 16. Conversely, due to the comparatively high flow resistance of the secondary line 16, the vast majority of the input exhaust gas flow 30 flows through the main line 14 when the control flap 22 is completely open.

In the merging chamber 20, the exhaust gas flow that has entered the merging chamber 20 via the main line 14 at least partly flows around the oxidation catalyst 28 or the section of the oxidation catalyst 28 that is arranged in the merging chamber 20 so that said oxidation catalyst 28 is heated by the heat of the exhaust gas flow flowing around it. This is particularly important when the catalyst 28 is comparatively cold and the exhaust gas has indeed not yet reached its normal operating temperature, but is warmer than the catalyst 28. For example, after a cold start or after a part-load operation, the enthalpy of the exhaust gas is used for heating the catalyst 28 to bring it to operating temperature more quickly. The control flap 22 is completely open in this state.

As soon as the catalyst 28 has reached a sufficiently high temperature, for example its operating temperature, the control flap 22 is (partly) closed to direct the exhaust gas (partly) through the secondary line 16. The main flow 24 is therefore reduced or even substantially completely stopped in favor of the secondary flow 26.

The input exhaust gas flow 30, which is now guided through the secondary line 16, is at least partly mixed with a hydrocarbon fluid (HC fluid) prior to entering the secondary line 16 in that an injector 34 sprays the HC fluid via a nozzle into a section of the branching chamber 18 and/or of the secondary line 16 (see spray cone 32 in FIG. 2), where the HC fluid mixes with the secondary flow 26. As shown in FIG. 2, the injector 34 is attached to the housing of the branching section 18 coaxially to a longitudinal axis of the secondary line 16.

The secondary flow 26 mixed with the HC fluid flows through the secondary line 16 and impacts the heating disk 31, which heats the exhaust gas hydrocarbon mixture, and then impacts the oxidation catalyst 28 and flows through it. The end section 29 of the secondary line 16 further has a widened portion that has the result that a cross-sectional area of the secondary line 16 increases at an outlet of the secondary line 16 and a larger area of the oxidation catalyst 28 is thereby flowed onto by exhaust gas. An exothermic oxidation of the injected hydrocarbon fluid (catalytic combustion) occurs in the oxidation catalyst 28, whereby the secondary flow 26 flowing through the oxidation catalyst 28 is heated and exits from the oxidation catalyst 28 as a heated secondary flow 36.

The heated secondary flow 36 is guided together with the exhaust gas flow from the merging chamber 20 to the outlet cover 38 that comprises the outlet opening 12, where the two exhaust gas flows mix and are fed to the downstream exhaust gas purification system 8 via the outlet opening 12.

A further embodiment of a heating module is shown in FIG. 3. The embodiment of FIG. 3 differs from the embodiment of FIG. 2 in that a funnel-like swirl element 40 and a slightly conical throttle element 42 are additionally provided in the branching section 18. The swirl element 40 surrounds the throttle element 42 in the peripheral direction that in turn surrounds the nozzle of the injector 34 in the peripheral direction. The throttle element 42 comprises, on the lateral surface, round throttle openings that are uniformly distributed in the peripheral direction and that form a kind of perforation. A trumpet-like or nozzle-like sleeve element 43 is arranged in the interior of the throttle element 42, wherein the shape of said sleeve element 45 is characterized in that it first tapers over a short distance in an injection direction of the HC fluid and then widens.

The total exhaust gas that enters into the secondary line 16 has passed through the swirl element 40 (in other embodiments, a bypass can also be provided). For this purpose, the swirl element 40 has openings with which angled guide surfaces are associated, whereby the exhaust gas flowing through the element 40 is given a swirl. A portion of the exhaust gas impacted by a swirl then flows directly into the secondary line 16. A small portion of the exhaust gas flows through the throttle element 42 and flows around the nozzle of the injector 34. Carried along by the spray cone 32 of the HC fluid and in cooperation with the shape of the sleeve element 42, this portion of the exhaust gas then flows through the sleeve element 42 into the secondary line 16, where it mixes with the other portion of the exhaust gas.

The components 40, 42, 43 ensure that the HC fluid can be sprayed into and mixed with the exhaust gas as efficiently as possible.

FIG. 4 shows a perspective view of the heating module 6 and in particular of the housing of the heating module 6. There are shown the inlet opening 10 through which the input exhaust gas flow 30 is guided from the internal combustion engine into the heating module 6, the branching section 18 with the injector 34 attached to the housing of the branching section 18, the main line 14 that comprises an opening via which the control flap 22 is in connection with an actuator, a part of the secondary line 16 (an end section of the secondary line 16 projects into the chamber 20, see FIG. 2), the merging chamber 20 that is in connection with the branching section 18 via the main line 14 and the secondary line 16, the connector 33 of the heating disk 31, and the outlet cover 38 that comprises the outlet opening 12 via which the exhaust gas flow of the heating module 6 is, for example, fed to an exhaust gas purification system 8.

FIG. 5 shows a side view of the heating module 6 having the same components.

FIG. 6 shows a front view of the heating module 6, wherein, in addition to the aforementioned components of the heating module 6, an actuator, in this case a motor 44, of the control flap is shown that is, for example, controlled via a control unit in order to set the setting angle of the control flap 22.

It can clearly be seen from FIGS. 4 to 6 that the module 6 has a very compact design.

### REFERENCE NUMERAL LIST

2 exhaust gas system
4 internal combustion engine
6 heating module
8 exhaust gas purification system
10 inlet opening
12 outlet opening
14 main line
16 secondary line
18 branching section
20 merging chamber
22 control device
24 main flow
26 secondary flow
28 oxidation catalyst
29 end section of the secondary line
30 input exhaust gas flow
31 heating disk
32 HC fluid
33 connector
34 injector
36 heated secondary flow
38 outlet cover
40 swirl element
42 throttle element
43 sleeve element
44 motor

1. A heating module for an exhaust gas system of an internal combustion engine, said heating module comprising at least one inlet opening and at least one outlet opening by means of which the heating module can be connected to the exhaust gas system, wherein a main line and a secondary line are provided between the inlet opening and the outlet opening to guide an exhaust gas flowing through the heating module, said main line and secondary line being in connection with one another at their upstream ends via a branching section and at their downstream ends via a merging chamber, wherein a control device for controlling the exhaust gas flow flowing through the main line is provided in the main line, and
wherein the heating module comprises an oxidation catalyst that is at least sectionally arranged in the merging chamber.

2. The heating module in accordance with claim 1,
wherein the oxidation catalyst is arranged at an outlet of the secondary line.

3. The heating module in accordance with claim 1,
wherein the oxidation catalyst is at least sectionally arranged spaced apart from a wall of the merging chamber.

4. The heating module in accordance with claim 1,
wherein an end section of the secondary line is at least sectionally arranged in the merging chamber.

5. The heating module in accordance with claim 1,
wherein an end section of the secondary line has a widened portion.

6. The heating module in accordance with claim 5,
wherein the oxidation catalyst is plugged into or pushed into the widened portion.

7. The heating module in accordance with claim 5,
wherein the oxidation catalyst is fastened to the widened portion.

8. The heating module in accordance with claim 1,
wherein the merging chamber is provided with an at least sectionally funnel-like outlet cover that has the outlet opening.

9. The heating module in accordance with claim 1,
wherein the merging chamber has an onflow wall arranged inclined to the main flow direction of the main line.

10. The heating module in accordance with claim 1,
wherein an injector is attached to the branching chamber and is configured to inject a fluid via a nozzle of the branching chamber into the branching chamber and/or the secondary line.

11. The heating module in accordance with claim 1,
wherein a swirl element is arranged in the branching section in order to impart a swirl component to the exhaust gas flow flowing through the secondary line.

12. The heating module in accordance with claim 11,
wherein the swirl element surrounds the nozzle in the peripheral direction.

13. The heating module in accordance with claim 1,
wherein the oxidation catalyst can be actively heated.

14. The heating module in accordance with claim 13,
wherein a heating element is provided for heating the exhaust gas flowing through the secondary line.

15. The heating module in accordance with claim 14,
wherein the heating element is arranged in front of the oxidation catalyst in the direction of flow.

16. The heating module in accordance with claim 14,
wherein the heating element is in contact with or is integrated into the oxidation catalyst.

17. An exhaust gas system comprising a heating module and an exhaust gas purification device arranged downstream of the heating module, said heating module comprising at least one inlet opening and at least one outlet opening by means of which the heating module can be connected to the exhaust gas system, wherein a main line and a secondary line are provided between the inlet opening and the outlet opening to guide an exhaust gas flowing through the heating module, said main line and secondary line being in connection with one another at their upstream ends via a branching section and at their downstream ends via a merging chamber, wherein a control device for controlling the exhaust gas flow flowing through the main line is provided in the main line, and
wherein the heating module comprises an oxidation catalyst that is at least sectionally arranged in the merging chamber.

18. A method for operating a heating module for an exhaust gas system of an internal combustion engine, wherein:
an exhaust gas flow is guided into a branching section via an inlet opening of the heating module;
the exhaust gas flow is guided from the branching section as a main flow in a main line and/or is guided from the branching section as a secondary flow in a secondary line;
the secondary flow at least partly flows through an oxidation catalyst for the catalytic combustion of a fluid introduced into the secondary flow;
the secondary flow and the main flow are combined in a merging chamber before the exhaust gas flow leaves the heating module via an outlet opening;
wherein the oxidation catalyst is at least sectionally arranged in the merging section and is flowed onto by the main flow; and
wherein a ratio of the mass flow of the main flow to the mass flow of the secondary flow is set by a control device arranged in the main line.

19. The method in accordance with claim 18, wherein the heating module comprises said at least one inlet opening and said at least one outlet opening by means of which the heating module can be connected to the exhaust gas system, the main line and the secondary line that are provided between the inlet opening and the outlet opening, said main line and secondary line being in connection with one another at their upstream ends via said branching section and at their downstream ends via said merging chamber, and wherein a control device for controlling the exhaust gas flow flowing through the main line is provided in the main line.

20. The method in accordance with claim 18,
wherein the mass flow of the main flow is maximized until the oxidation catalyst and/or the exhaust gas flow exiting from the heating module has/have reached a first target temperature;
wherein the mass flow of the main flow is reduced or minimized until the oxidation catalyst and/or the exhaust gas flow exiting from the heating module has/have reached a second target temperature that is above the first target temperature or until an external signal is received; and
wherein the mass flow of the main flow is increased or maximized again if the second target temperature has been maintained for a predetermined time period and/or for a time period determined based on operating data of the heating module and/or based on external data or if an external signal is received.

21. The method in accordance with claim 20,
wherein the mass flow of the main flow is reduced or minimized in a normal load operation until the oxidation catalyst and/or the exhaust gas flow exiting from the heating module reaches or exceeds a third target temperature that is above the second target temperature or until an external signal is received.

22. A method in accordance with claim 20,
wherein the third target temperature is maintained for a predetermined time period and/or for a time period determined based on operating data of the heating module and/or based on external data.
